(19) United States
(12) Patent Application Publication
(10) Pub. No.: US 2015/0019376 A1
(43) Pub. Date: Jan. 15, 2015

(54) SYSTEM AND METHOD FOR USING TRUSTED DEVICE TO BROWSE E-BOOK

(71) Applicant: NATIONAL CHENG KUNG UNIVERSITY, Tainan City (TW)

(72) Inventors: YUEH-MIN HUANG, TAINAN CITY (TW); YU-LIN JENG, TAINAN CITY (TW); CHIA-JU LIU, TAINAN CITY (TW); YEN-HUNG KUO, TAINAN CITY (TW); YEN-NING SU, TAINAN CITY (TW)

(73) Assignee: NATIONAL CHENG KUNG UNIVERSITY, Tainan City (TW)

(21) Appl. No.: 14/040,927

(22) Filed: Sep. 30, 2013

(30) Foreign Application Priority Data
Jul. 15, 2013 (TW) 102125180

(51) Int. Cl. G06Q 30/06

(52) U.S. Cl. CPC G06Q 30/0609; G06Q 30/0603
USPC 705/26.35

(57) ABSTRACT

The invention relates to a system and a method for using a trusted device to browse e-books. The system comprises an author end, a user end, an electronic bookstore unit, and a data storage unit. In the cloud system, an e-book author can set the authorization mechanism about e-book sale and downloading to protect their copyrights and to upload the e-book by the electronic bookstore unit. The user also can browse e-books by assigned electronic apparatuses to protect purchase rights from being illegally copied. The e-book is an encrypted file, so the user has to use the identification code of the certified electronic apparatus as a decrypted key to decrypt the e-book file for reading.

### BACKGROUND OF THE INVENTION

1. Field of the Invention

The invention relates to a system and a method for using a trusted device to browse e-books. The system comprises an author end, a user end, an electronic bookstore unit, and a data storage unit. In the cloud system, an e-book author can set the authorization mechanism about e-book sale and downloading to protect their copyrights and to upload the e-book by the electronic bookstore unit. The user also can browse e-books by assigned electronic apparatuses to protect purchase rights from being illegally copied. The e-book is an encrypted file, so the user has to use the identification code of the certified electronic apparatus as a decrypted key to decrypt the e-book file for reading.

2. Description of Related Art

After Johannes Gutenberg invented the printing, human civilization has been widely documented resulting in universal education. Social power from the hands of a few nobles gradually transferred to the public leading to development and progress of society. In the knowledge and economy eras driven by universal education, paper and books were playing an important role in knowledge transmission. Moreover, cultivating a reading habit was also an important process for obtaining information and knowledge in human life. However, as electronic technology advances, paper and books were no longer the only carrier of knowledge. For instance, Project Gutenberg, in AD 1971, was to allow literature without controversial copyright to be uploaded to the Internet for readers to download into an electronic version of the text. This indicated that information transmission methods may change according to the different recording ways of media. Through the Internet and other carriers, knowledge could be spread much wider than before, and readers as well as e-books of electronic apparatuses were thus generated due to this feature.

With the advent of the digital era, digital resources have begun to attract much more attention than before. The so-called digital resource means a variety of information being digitized, systemized, and structured for people to read and reuse by means of different devices. It comprises e-books, e-journals, theses databases, and electronic newspapers, etc., in which the e-book is the most important application of digital resources. The appearance and development of e-books create a new field of the current printing and publishing skills. In comparison with the traditional print book, the e-book has many advantages, i.e. saving on printing, publishing and production processes, and ability of accepting more types of file formats, so that it contributes to the circulation and dissemination of knowledge of books. Accordingly, the e-book seems to have played an important role in the book market in recent years. In addition, the popularity of handheld electronic devices also directly leads to the growth of the e-book market, so electronic or digital reading mode has become an irresistible trend in the world with the development and the promotion of e-books. Moreover, unlike the traditional books that require numerous and complicated procedures as well as high production costs for realizing publication of a physical book, e-books only require applications of typesetting and selling related skills for making thereof, which can effectively solve the problems of book publication and production. Nowadays everyone can incorporate his or her knowledge and ideas into the e-book on e-book related service websites as well as achieve the purpose of selling e-books by means of providing consumers for previewing several pages of an e-book.

However, with the gradual maturity of an e-book development, many problems, such as authors' copyrights and illegal copies by others, have also emerged, so lots of e-book related protection methods and technologies are becoming imperative. Generally, the service websites only allow reader to read e-books by browsing them online. If someone wants to download e-books through the electronic apparatus, he or she must be certified by the authentication mechanism, e.g. previously entering the certified account number and password or the identification code of the electronic apparatus before starting to download the e-book content. Therefore, such a mechanism can effectively stop others without the consent to download the e-book content from the service website. Although the authentication mechanism can effectively prevent the unauthorized downloading behavior, it cannot prohibit the unauthorized electronic apparatuses or people from getting the e-book content downloaded by certified electronic apparatus intentionally or unintentionally by means of wired or wireless transmission. This will seriously jeopardize copyrights of e-book authors and publishers. Therefore, how to effectively ensure authors copyrights to help authors concentrate their efforts on creation for further providing much better works as well as ensure the purchase rights for consumers are still imperative issues required to be solved by e-book system developers and researchers.

### SUMMARY OF THE INVENTION

In view of the above-mentioned problems, the object of the present invention is to provide a system and a method for using a trusted device to browse e-books. In the cloud system, an e-book author can set the authorization mechanism to protect their copyrights and to upload the e-book file by an electronic bookstore unit. The user can also browse e-books by assigned electronic apparatuses to protect purchase rights from being illegally copied.

Disclosed herein is a system for using a trusted device to browse e-books, comprising an author end, a user end, an electronic bookstore unit and a data storage unit.

The author end receives an e-book file and an authorization setting uploaded by an e-book author by means of the Internet. the user end includes at least one electronic apparatus possessed by a user. the electronic bookstore unit which is a cloud system includes an author interface for providing the author end authorization and uploading and a user interface for providing the user end certification and downloading. The author interface consists of an authorization interface providing the author end for setting an authorization mechanism to download the e-book and an upload interface providing the author end for uploading the e-book file. The user interface consists of a certification interface for providing the user end registration and certification of user's electronic apparatus and a download interface for providing the user end for downloading the e-book file. The data storage unit electrically connects to the electronic bookstore unit and includes an e-book database, an authorization database, and a certification database. The e-book database stores the e-book file uploaded from the author end through the upload interface, and the user end downloads the e-book file stored in the e-book database through the download interface. The authorization database stores the authorization setting of the e-book file downloaded by the author end through the authorization interface. The certification database stores the certification and registration information of the electronic apparatus.

Therefore, e-book authors can protect their copyrights and ensure that their works can be downloaded and read merely in the monitored environment. Only the registered and authenticated users can download and purchase e-books based on the premise of having user permissions and browsing device limitation, so as to protect their purchase rights against being shared or illegal use of others.

According to an embodiment of the present invention, the electronic apparatus including a display module to provide the user end for reading the e-book file is selected from the group consisting of desktop computer, portable computer, smart phones and tablet computer.

According to an embodiment of the present invention, the authorization mechanism set by the author end comprises the download frequency of the e-book file by the allowed user end, the number of the electronic apparatuses browsing the e-book file at the same time, the fee the user end need to pay for purchasing the e-book file, the number of pages the user end read before purchasing the e-book file, or a combination thereof.

According to an embodiment of the present invention, the certification information on the electronic apparatus includes a unification identification code (UID).

Furthermore, a method for using a trusted device to browse e-books is also revealed herein, comprises steps of: primarily, an author end setting an authorization mechanism for downloading an e-book file by an authorization interface of an author interface in an electronic bookstore unit, wherein an authorization value is stored in an authorization database of a data storage unit; next, the author end uploading the e-book file to an e-book database of the data storage unit for storage by an upload interface of the author interface; then a user end registering and certifying the electronic apparatus by a certification interface of a user interface in the electronic bookstore unit, wherein the certification information is stored in a certification database of the data storage unit; and finally the user end using the certified electronic apparatus to download the e-book file by the download interface of the user interface, wherein the e-book file is an encrypted file. The user end must use the identification code of the electronic apparatus as a decrypted key to decrypt the e-book file for reading. Accordingly, e-book authors can protect their copyrights and ensure that their e-books will not be stolen. In addition, consumers also can prevent the e-books they purchased from being illegally copied and trafficking.

As mentioned above, the method for using a trusted device to browse e-books according to the present invention can further be used in combination of hardware, software, any appropriate place or a combination thereof. Besides, some of the arguments of the present method may be incorporated into the program codes of the actual media. For instance, the program code can be an application (aka APP) applied to computer's instruction or handheld electronic device, and the actual media can be floppy disks, optic disk drives, hard disks or any other machine readable storage media. When the program code or APP are loaded by a machine (e.g. a computer) and executed, this machine can become a device for the implementation of the present invention. In such a case, the computer device typically contains a central processing unit (CPU), a CPU readable storage medium (including a volatile or non-volatile memory and/or storage elements), at least one input unit, and at least one output unit.

### BRIEF DESCRIPTION OF THE DRAWINGS

FIG. 1 a block diagram showing a system for using a trusted device to browse e-books according to the present invention.

FIG. 2 is a flow chart showing a method for using a trusted device to browse e-books according to the present invention.

### DETAILED DESCRIPTION OF THE PREFERRED EMBODIMENT

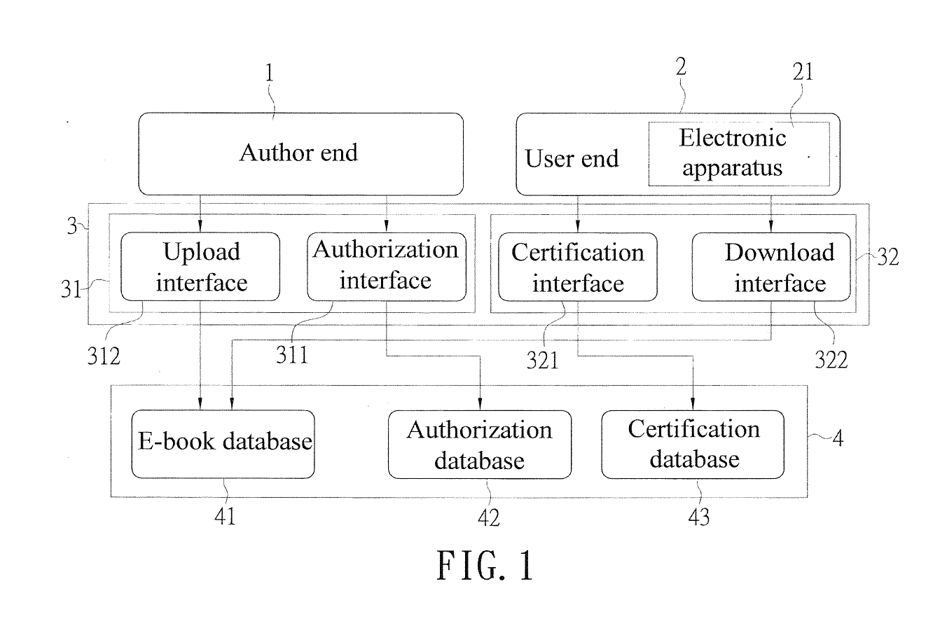

A system and a method for using a trusted device to browse e-books are disclosed herein. Referring to FIG. 1, it is a block diagram showing a system for using a trusted device to browse e-books according to the present invention. The system for using a trusted device to browse e-books comprises:

an author end (1) for receiving an e-book file and an authorization setting uploaded by an e-book author by means of the Internet;

a user end (2) including at least one electronic apparatus (21) possessed by a user;

an electronic bookstore unit (3), which is a cloud system including an author interface (31) for providing the author end (1) authorization and uploading and a user interface (32) for providing the user end (2) certification and downloading. The author interface (31) consists of an authorization interface (311) providing the author end (1) for setting an authorization mechanism to download the e-book and an upload interface (312) providing the author end (1) for uploading the e-book file. The user interface (32) consists of a certification interface (321) for providing the user end (2) registration and certification of user's electronic apparatus (21) and a download interface (322) for providing the user end (2) for downloading the e-book file; and

a data storage unit (4) electrically connecting to the electronic bookstore unit (3) and including an e-book database (41), an authorization database (42), and a certification database (43). The e-book database (41) stores the e-book file uploaded from the author end (1) through the upload interface (312), and the user end (2) downloads the e-book file stored in the e-book database (41) through the download interface (322). The authorization database (42) stores the authorization setting of the e-book file downloaded by the author end (1) through the authorization interface (311). The certification database (43) stores the certification and registration information of the electronic apparatus (21).

In the foregoing description, the electronic apparatus (21) including a display module to provide the user end (2) for reading the e-book file is selected from the group consisting of desktop computer, portable computer, smart phones and tablet computer. The authorization mechanism set by the author end (1) comprises the download frequency of the e-book file by the allowed user end (2), the number of the electronic apparatuses (21) browsing the e-book file at the same time, the fee the user end (2) need to pay for purchasing the e-book file, the number of pages the user end (2) read before purchasing the e-book file, or a combination thereof. The certification information on the electronic apparatus (21) includes a unification identification code (UID).

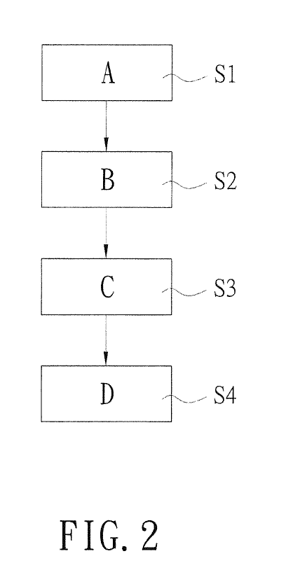

Hereinafter, an exemplary embodiment of the present invention will be described in detail with reference to the accompanying drawings. Referring to FIG. 2, a flow chart showing a method for using a trusted device to browse e-books according to the present invention is revealed, comprising steps of:

(A) (S1): an author end (1) setting an authorization mechanism for downloading an e-book file by an authorization interface (311) of an author interface (31) in an electronic bookstore unit (3), wherein an authorization value is stored in an authorization database (42) of a data storage unit (4);

(B) (S2): the author end (1) uploading the e-book file to an e-book database (41) of the data storage unit (4) for storage by an upload interface (312) of the author interface (31);

(C) (S3): a user end (2) registering and certifying the electronic apparatus (21) by a certification interface (321) of a user interface (32) in the electronic bookstore unit (3), wherein the certification information is stored in a certification database (43) of the data storage unit (4); and

(D) (S4): the user end (2) using the certified electronic apparatus (21) to download the e-book file by the download interface (322) of the user interface (32), wherein the e-book file is an encrypted file. The user end (2) must use the identification code of the electronic apparatus (21) as a decrypted key to decrypt the e-book file for reading.

Additionally, as described above, the method for using a trusted device to browse e-books according to the present invention can further be used in combination of hardware, software, any appropriate place or a combination thereof. Besides, some of the arguments of the present method may be incorporated into the executable instructions of the computer readable medium. For instance, the executable instruction can be an application (aka APP) applied to computer's instruction or handheld electronic device, and the computer readable medium may comprise the apparatuses, i.e. an electrical transmission module (electronic media) having at least one wire, a portable computer disk (magnetic media), a random access memory (RAM) (electronic media), a read-only memory (ROM) (electronic media), a erasable and programmable read-only memory (EPROM, EEPROM, or flash memory) (electronic media), an optical fiber (optical media), a portable compact disc read-only memory (CDROM) (optical media) and so on. When the program code or APP are loaded by a machine (e.g. a computer) and executed, this machine can become a device for the implementation of the present invention. In such a case, the computer device typically contains a central processing unit (CPU), a CPU readable storage medium (including a volatile or non-volatile memory and/or storage elements), at least one input unit, and at least one output unit.

According to the above description, in comparison with the traditional technique, a system and a method for using a trusted device to browse e-books according to the present invention have the advantages as following:

1. The present invention allows the authors to safeguard their own rights and interests of e-books by the design of the electronic bookstore unit and to ensure that their works can be downloaded and read merely in the monitored environment. Therefore, only the registered and authenticated users can download and purchase e-books based on the premise of having user permissions and browsing device limitation so as to effectively protect authors' copyrights.

2. Since only the registered and certified electronic apparatuses are permitted browsing, purchasing and downloading e-book files, the present invention can also effectively protect users' purchase rights against being shared or illegal use of others and can effectively enhance the rights security of all users on the e-book platform.

3. The present invention not only can improve the current operation of electronic mall by providing authorization mechanism for purchasing e-books but also extend the e-book selling business and the authorized devices for purpose of effectively increasing e-book author's works and investors' willingness.

What is claimed is:

1. A system for using a trusted device to browse e-books comprises:
an author end for receiving an e-book file and an authorization setting uploaded by an e-book author by means of the Internet;
an user end including at least one electronic apparatus possessed by an user;
an electronic bookstore unit which is a cloud system including an author interface for authorization and uploading of the user end and an user interface for certification and downloading of the user end, wherein the author interface consists of an authorization interface for setting an authorization mechanism by the author end to download the e-book and an upload interface for uploading of the e-book file by the author end, and the user interface consists of a certification interface for registration and certification of user's electronic apparatus by the user end and a download interface for providing for downloading the e-book file by the user end; and
a data storage unit electrically connecting to the electronic bookstore unit and including an e-book database, an authorization database, and a certification database, wherein the e-book database stores the e-book file uploaded from the author end through the upload interface, the user end downloads the e-book file stored in the e-book database through the download interface, the authorization database stores the authorization setting of the e-book file downloaded by the author end through the authorization interface, and the certification database stores the certification and registration information of the electronic apparatus.

2. The system for using a trusted device to browse e-books as claimed in claim 1, wherein the electronic apparatus including a display module to provide the user end for reading the e-book file is selected from the group consisting of desktop computer, portable computer, smart phones and tablet computer.

3. The system for using a trusted device to browse e-books as claimed in claim 1, wherein the authorization mechanism set by the author end comprises the download frequency of the e-book file by the allowed user end, the number of the electronic apparatuses browsing the e-book file at the same time, the fee the user end need to pay for purchasing the e-book file, the number of pages the user end read before purchasing the e-book file, or a combination thereof.

4. The system for using a trusted device to browse e-books as claimed in claim 1, wherein the certification information on the electronic apparatus includes a unification identification code (UID).

5. A method for using a trusted device to browse e-books comprises steps of:
(A): an author end setting an authorization mechanism for downloading an e-book file by an authorization interface of an author interface in an electronic bookstore unit, wherein an authorization value is stored in an authorization database of a data storage unit;
(B): the author end uploading the e-book file to an e-book database of the data storage unit for storage by an upload interface of the author interface;
(C): a user end registering and certifying the electronic apparatus by a certification interface of a user interface in the electronic bookstore unit, wherein the certification information is stored in a certification database of the data storage unit; and
(D): the user end using the certified electronic apparatus to download the e-book file by the download interface of the user interface, wherein the e-book file is an encrypted file, and further decrypt the e-book for reading purposes by use of an identification code of the electronic apparatus as a decrypted key.

6. The method for using a trusted device to browse e-books as claimed in claim 5, wherein the electronic apparatus including a display module for providing the user end to read the e-book file is selected from the group consisting of desktop computer, portable computer, smart phones and tablet computer.

7. The method for using a trusted device to browse e-books as claimed in claim 5, wherein the authorization mechanism set by the author end comprises the download frequency of the e-book file by the allowed user end, the number of the electronic apparatuses browsing the e-book file at the same time, the fee the user end need to pay for purchasing the e-book file, the number of pages the user end read before purchasing the e-book file, or a combination thereof.

8. The method for using a trusted device to browse e-books as claimed in claim 5, wherein the certification information on the electronic apparatus includes a unification identification code (UID)

9. A computer readable media at least comprises a computer executable module having computer executable instructions for execution of the method as claimed in claim 5.
